(19) United States
(12) Patent Application Publication
(10) Pub. No.: US 2021/0158726 A1
(43) Pub. Date: May 27, 2021

(54) Tubing Marking System

(71) Applicant: Jeffrey Lynn Rose, Meadow Vista, CA (US)

(72) Inventor: Jeffrey Lynn Rose, Meadow Vista, CA (US)

(21) Appl. No.: 17/102,251

(22) Filed: Nov. 23, 2020

Related U.S. Application Data
(60) Provisional application No. 62/938,788, filed on Nov. 21, 2019.
(60) Provisional application No. 62/953,851, filed on Dec. 26, 2019.

(51) Int. Cl. G09F 3/00; G09F 3/10; G09F 3/20

(52) U.S. Cl. CPC G09F 3/0295; A01G 25/02; G09F 3/201; G09F 3/10

(57) ABSTRACT

A tubing marking system is provided primarily for tubing utilized in drip irrigation processes. The tubing marking system includes a tube, a plurality of elongated markings, and a plurality of elongated covers. The tube is preferably made of a flexible material and includes an outer diameter of 0.5 inches or larger. More specifically, the tube is preferably made of polyethylene material. The plurality of elongated markings may be a set of any type of markings that can be easily identified by a user. The plurality of elongated covers may be a set of any type of material able to partially or fully conceal the plurality of elongated markings. When the tubing marking system is in use, at least one cover from the plurality of elongated covers is detached from the tube in order to expose the corresponding marking. This allows one tube to be visually distinguished from another tube.

The current application claims a priority to the U.S. Provisional Patent application Ser. No. 62/938,788 filed on Nov. 21, 2019 and a priority to the U.S. Provisional Patent application Ser. No. 62/953,851 filed on Dec. 26, 2019. The current application is filed on Nov. 23, 2020 while Nov. 21, 2020 was on a weekend.

### FIELD OF THE INVENTION

The present invention generally relates to irrigation systems and coding systems. More specifically, the present invention provides a tubing marking system that is primarily for tubing utilized in drip irrigation processes.

### BACKGROUND OF THE INVENTION

When installing polyethylene tubing for a drip irrigation system, a trench is often dug to conceal multiple polyethylene tubing lines. Even when not run in a single trench, the tubing is almost always covered. Additionally, the tubing often originates from a single location where multiple valves are located, which can cause problems when trying to distinguish one line from the other. Once the trench is covered and the initial installation completed, users cannot easily distinguish one line from another without constantly going back to the sprinkler valve and turning water on to each valve to see which line is activated. Furthermore, the problem is exacerbated when, after a while, users desire to tap into a particular line in order to add an additional water source for a plant, but the original tubing has been added to and/or users have no idea how the original installation was done and cannot locate the desired line.

An objective of the present invention is to provide a tubing marking system for standard drip irrigation tubing. The present invention is preferably designed for polyethylene tubing in the ½″ outer diameter, ⅝″ outer diameter or larger, oval hosing, or any flexible tubing used for drip irrigation. The tubing marking system provides marking lines of approximately ⅛″ wide in various colors, symbols, or numbers applied to the tubing during the manufacturing process. The marking lines can be applied to the surface of the tubing or embedded in the tubing and run the entire length of the tubing. While any number of marking lines can be applied to the tubing, the present invention preferably provides four to five separate marking lines. The marking lines are sufficiently unique and vivid to allow for ease in distinguishing one marking line from another.

### BRIEF DESCRIPTION OF THE DRAWINGS

FIG. 1 is a right-side view of the present invention.

FIG. 2 is a front right-side perspective view of the present invention.

FIG. 3 is a front view of the present invention.

FIG. 4 is a front schematic view of the present invention illustrating the semi-transparent strip and the adhesive layer.

FIG. 5 is a detailed view taken about circle 5-6-7 in FIG. 1 illustrating one embodiment for the plurality of elongated markings.

FIG. 6 is a detailed view taken about circle 5-6-7 in FIG. 1 illustrating another embodiment for the plurality of elongated markings.

FIG. 7 is a detailed view taken about circle 5-6-7 in FIG. 1 illustrating another embodiment for the plurality of elongated markings.

### DETAIL DESCRIPTIONS OF THE INVENTION

All illustrations of the drawings are for the purpose of describing selected versions of the present invention and are not intended to limit the scope of the present invention.

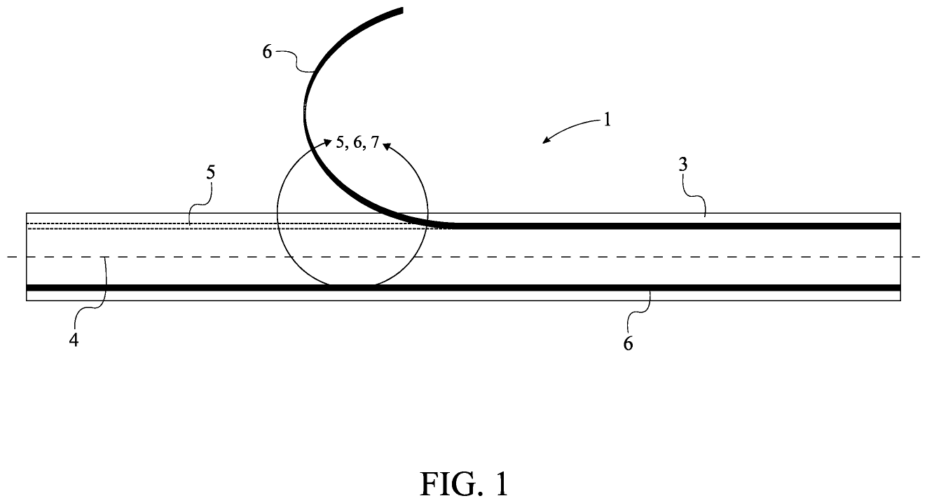

In reference to FIGS. 1 through 7, the present invention is a tubing marking system that is primarily for tubing utilized in drip irrigation processes. The tubing marking system may comprise a tube 1, a plurality of elongated markings 5, and a plurality of elongated covers 6. The tube 1 is preferably made of a flexible material and includes an outer diameter of a half-inch or larger. More specifically, the tube 1 is preferably made of polyethylene material. The plurality of elongated markings 5 may be a set of any type of markings that can be easily identified by a user. The plurality of elongated covers 6 may be a set of any type of material able to partially or fully conceal the plurality of elongated markings partially or fully 5.

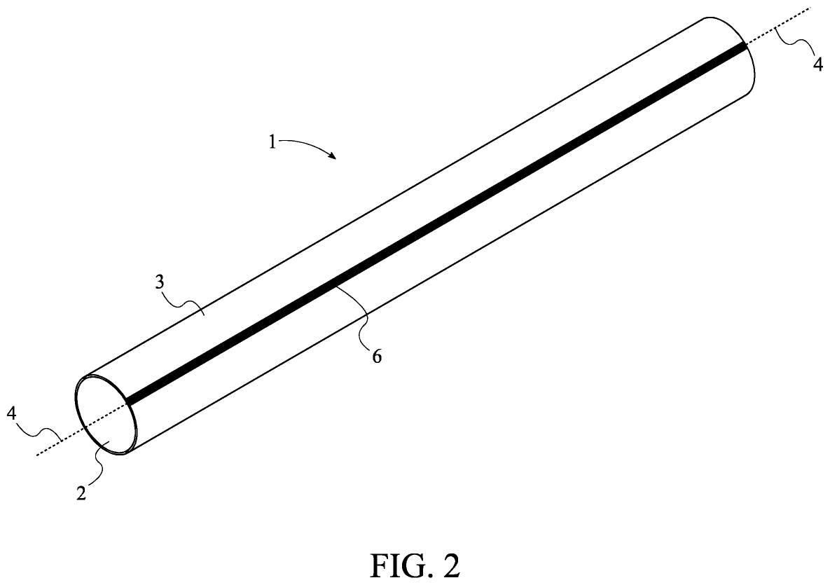

The general configuration of the aforementioned components allows the user to distinguish one tube from another in a drip irrigation system. With reference to FIGS. 1 and 2, the tube 1 comprises an inner lateral surface 2 and an outer lateral surface 3. The plurality of elongated markings 5 is inscribed onto the outer lateral surface 3. This arrangement allows the plurality of elongated markings 5 to be easily visible to the user if the plurality of elongated markings 5 is not concealed by the plurality of elongated covers 6. More specifically, the plurality of elongated markings 5 can be infused or embedded onto the outer lateral surface 3 in order to not alter the outer diameter of the tube 1. Each of the plurality of elongated markings 5 is positioned parallel to a central axis 4 of the tube 1. This arrangement positions the plurality of elongated markings 5 so that each of the plurality of elongated markings 5 spans the entire length of the tube 1. Further, the plurality of elongated markings 5 is radially distributed about the outer lateral surface 3. This arrangement evenly spaces out each marking about the outer lateral surface 3 so the user can easily distinguish one elongated marking line from another. The plurality of elongated covers 6 is attached onto the tube 1. In more detail, the plurality of elongated covers 6 may be attached in various methods such as, but not limited to, using an adhesive or other similar attachment means. Moreover, the plurality of elongated covers 6 is positioned along a corresponding marking from the plurality of elongated markings 5. This arrangement allows the plurality of elongated covers 6 to cover each and all of the plurality of elongated markings 5. When the present invention is in use, at least one cover from the plurality of elongated covers 6 is detached from the tube 1 in order to expose the corresponding marking. This allows the tube 1 to be distinguished from a tube 1 in another iteration of the present invention.

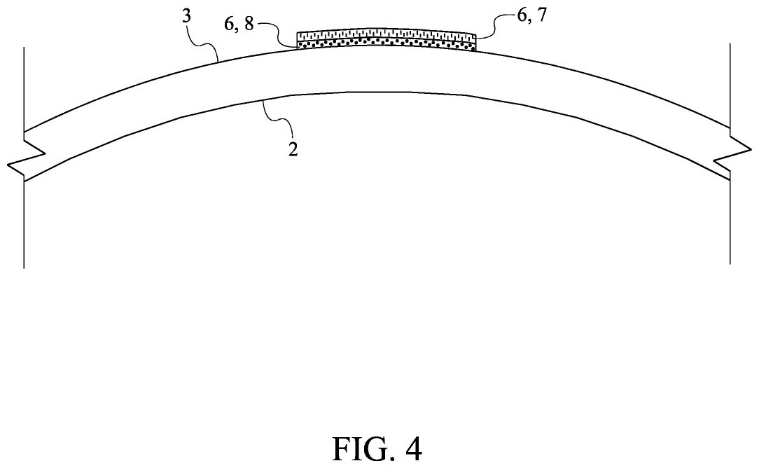

In order for the user to be able to identify a type of marking without removing the cover and for each cover to be attached onto the tube 1 and with reference to FIG. 4, each of the plurality of elongated covers 6 may comprise a semi-transparent strip 7 and an adhesive layer 8. The semi-transparent strip 7 partially conceals the corresponding marking allowing the user to identify the type of marking before completely detaching the elongated cover 6 from the tube 1. The semi-transparent strip 7 along with the adhesive layer 8 is preferably a quarter-inch wide strip of adhesive tape. The adhesive layer 8 is superimposed across the semi-transparent strip 7, and the semi-transparent strip 7 is attached onto the tube 1 by the adhesive layer 8. Thus, each of the plurality of elongated covers 6 only partially conceals the corresponding marking and is preferably adhered onto the tube 1.

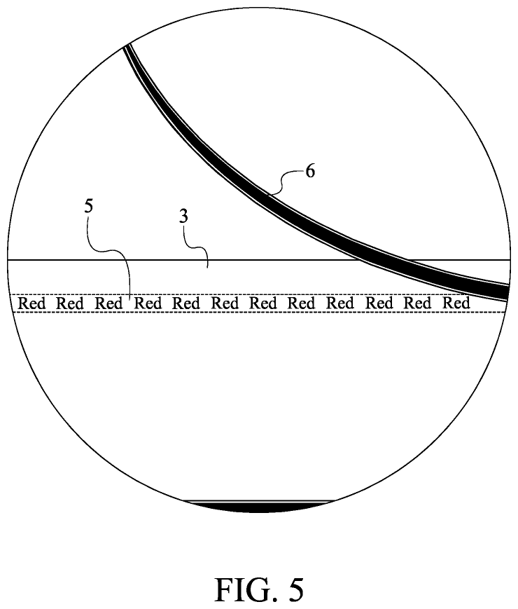

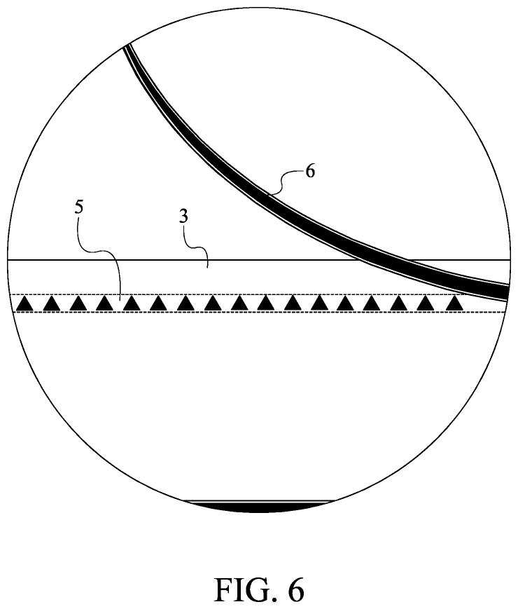

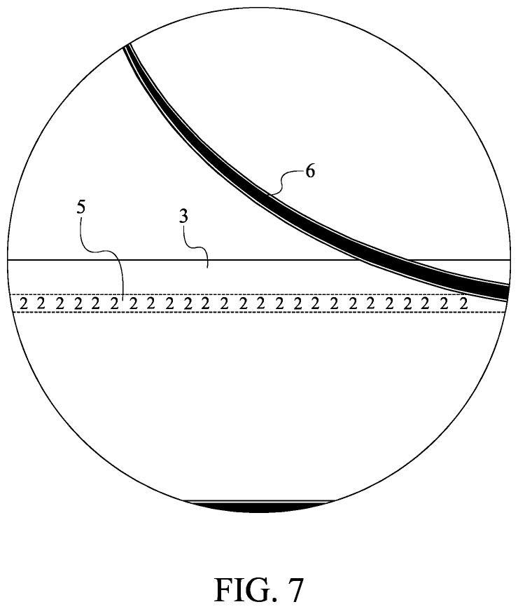

As mentioned previously, the plurality of elongated markings 5 may be a set of any type of markings that can be easily identified by the user. In one embodiment and with reference to FIG. 5, each of the plurality of elongated markings 5 is a corresponding color from a plurality of different colors. The plurality of different colors may be a set of colors such as, but not limited to, blue, green, yellow, orange, or red. In another embodiment and with reference to FIG. 6, each of the plurality of elongated markings 5 is a corresponding graphic from a plurality of different symbol-based graphics. The plurality of different symbol-based graphics may be a set of symbols such as, but not limited to, triangles, squares, circles, crosses, or dashes. In another embodiment and with reference to FIG. 7, each of the plurality of elongated markings 5 is a corresponding graphic from a plurality of different number-based graphics. The plurality of different number-based graphics may be a set of numbers, such as, but no limited to, the numbers from 1 through 10. Moreover, in order for the user to easily distinguish a marking on the tube 1, the outer lateral surface 3 is configured to visually contrast the plurality of elongated markings 5. In more detail, the outer lateral surface 3 may be a different color than each of the plurality of elongated markings 5.

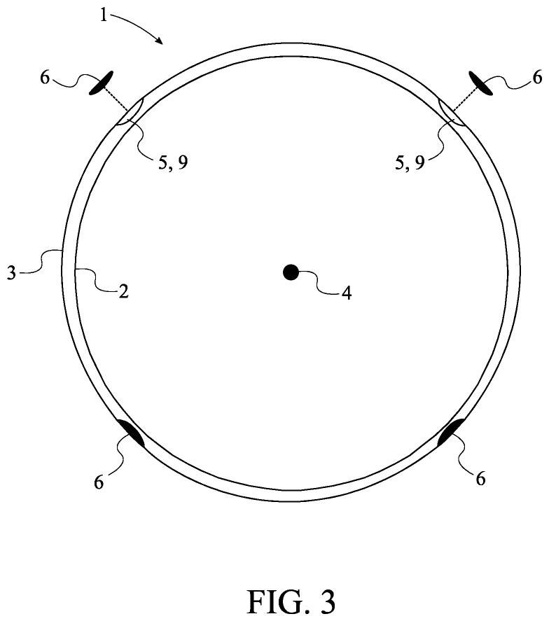

In order for the tube 1 to maintain a consistent outer diameter with the plurality of elongated covers 6 attached onto the tube 1 and with reference to FIG. 3, the present invention may further comprise a plurality of elongated grooves 9. The plurality of elongated grooves 9 is integrated into the outer lateral surface 3. In further detail, the plurality of elongated grooves 9 is cut into the outer lateral surface 3. Each of the plurality of elongated grooves 9 is positioned parallel to the central axis 4 of the tube 1. This arrangement positions the plurality of elongated grooves 9 so that each elongated groove 9 spans the entire length of the tube 1. Further, the plurality of elongated grooves 9 is radially distributed about the outer lateral surface 3, and each of the plurality of elongated markings 5 is inscribed into a corresponding groove from the plurality of elongated grooves 9. Thus, there is one elongated groove 9 for each elongated marking 5. Moreover, each of the plurality of elongated covers 6 is positioned into the corresponding groove of the corresponding marking. Thus, the plurality of elongated covers 6 is used to partially or fully conceal both the corresponding groove and the corresponding marking. Moreover, each of the plurality of elongated covers 6 is configured to be flush with the outer lateral surface 3. Thus, the tube 1 can maintain a consistent outer diameter with the plurality of elongated covers 6 attached onto the tube 1.

### Supplemental Description

During installation, the user/installer may want to provide water to four separate areas:

Area #1: Trees throughout the yard which require heavy watering once a week;

Area #2: Flowers that require light watering once a day;

Area #3: Bushes which require watering every other day; and,

Area #4: Succulents that require minimal watering once a week.

During installation of a drip irrigation system using the present invention and in the embodiment, where each of the plurality of elongated markings 5 is a corresponding color from the plurality of colors, the user/installer can designate area #1 to be a tube with a red color marking; area #2 to be a tube with a blue color marking; area #3 to be a tube with a green color making; and, area #4 to be a tube with a yellow color marking. This designation of color markings is done by simply removing at least one cover from the plurality of elongated covers 6 of the corresponding marking. The user/installer can also place a small marking dot on the top of the valve corresponding to the designated marking of the tube controlled by that valve. If additional tubing lines are needed, and therefore must be individually identified, the user simply removes two covers thereby revealing two separate color markings.

Since the various plants are spread out throughout the yard, the individual tubes, which provide the water, are also spread out throughout the yard. When the user wants to plant additional flowers, for example, the user simply finds the tube designated by the blue color marking, thus providing the proper amount of water to the new planting. Likewise, if the user desires to modify the amount of water going to the trees, the user knows to adjust the valve that controls tube with the red color marking.

Although the invention has been explained in relation to its preferred embodiment, it is to be understood that many other possible modifications and variations can be made without departing from the spirit and scope of the invention as hereinafter claimed.

What is claimed is:

1. A tubing marking system comprises:
a tube;
a plurality of elongated markings;
a plurality of elongated covers;
the tube comprises an inner lateral surface and an outer lateral surface;
the plurality of elongated markings being inscribed onto the outer lateral surface;
each of the plurality of elongated markings being positioned parallel to a central axis of the tube;
the plurality of elongated markings being radially distributed about the outer lateral surface;
the plurality of elongated covers being attached onto the tube; and
each of the plurality of elongated covers being positioned along a corresponding marking from the plurality of elongated markings.

2. The tubing marking system as claimed in claim 1 comprises:
each of the plurality of elongated covers comprises a semi-transparent strip and an adhesive layer;
the adhesive layer being superimposed across the semi-transparent strip; and
the semi-transparent strip being attached onto the tube by the adhesive layer.

3. The tubing marking system as claimed in claim 1 comprises:
the tube being made of polyethylene material.

4. The tubing marking system as claimed in claim 1 comprises:
each of the plurality of elongated markings being a corresponding color from a plurality of different colors.

5. The tubing marking system as claimed in claim 1 comprises:
each of the plurality of elongated markings being a corresponding graphic from a plurality of different symbol-based graphics.

6. The tubing marking system as claimed in claim 1 comprises:
each of the plurality of elongated markings being a corresponding graphic from a plurality of different number-based graphics.

7. The tubing marking system as claimed in claim 1 comprises:
the outer lateral surface being configured to visually contrast the plurality of elongated markings.

8. The tubing marking system as claimed in claim 1 comprises:
a plurality of elongated grooves;
the plurality of elongated grooves being integrated into the outer lateral surface;
each of the plurality of elongated grooves being positioned parallel to the central axis of the tube;
the plurality of elongated grooves being radially distributed about the outer lateral surface; and
each of the plurality of elongated markings being inscribed into a corresponding groove from the plurality of elongated grooves.

9. The tubing marking system as claimed in claim 8 comprises:
each of the plurality of elongated covers being positioned into the corresponding groove of the corresponding marking; and
each of the plurality of elongated covers being configured to be flush with the outer lateral surface.

10. A tubing marking system comprises:
a tube;
a plurality of elongated markings;
a plurality of elongated covers;
the tube comprises an inner lateral surface and an outer lateral surface;
each of the plurality of elongated covers comprises a semi-transparent strip and an adhesive layer;
the plurality of elongated markings being inscribed onto the outer lateral surface;
each of the plurality of elongated markings being positioned parallel to a central axis of the tube;
the plurality of elongated markings being radially distributed about the outer lateral surface;
each of the plurality of elongated covers being positioned along a corresponding marking from the plurality of elongated markings;
the tube being made of polyethylene material;
the outer lateral surface being configured to visually contrast the plurality of elongated markings;
the adhesive layer being superimposed across the semi-transparent strip; and
the semi-transparent strip being attached onto the tube by the adhesive layer.

11. The tubing marking system as claimed in claim 10 comprises:
each of the plurality of elongated markings being a corresponding color from a plurality of different colors.

12. The tubing marking system as claimed in claim 10 comprises:
each of the plurality of elongated markings being a corresponding graphic from a plurality of different symbol-based graphics.

13. The tubing marking system as claimed in claim 10 comprises:
each of the plurality of elongated markings being a corresponding graphic from a plurality of different number-based graphics.

14. The tubing marking system as claimed in claim 10 comprises:
a plurality of elongated grooves;
the plurality of elongated grooves being integrated into the outer lateral surface;
each of the plurality of elongated grooves being positioned parallel to the central axis of the tube;
the plurality of elongated grooves being radially distributed about the outer lateral surface; and
each of the plurality of elongated markings being inscribed into a corresponding groove from the plurality of elongated grooves.

15. The tubing marking system as claimed in claim 15 comprises:
each of the plurality of elongated covers being positioned into the corresponding groove of the corresponding marking; and
each of the plurality of elongated covers being configured to be flush with the outer lateral surface.
